(19) United States
(12) Patent Application Publication
(10) Pub. No.: US 2005/0143909 A1
(43) Pub. Date: Jun. 30, 2005

(54) Technique for collecting and using information about the geographic position of a mobile object on the earth's surface

(76) Inventor: Jonathan Lee Orwant, Cambridge, MA (US)

Correspondence Address: COHEN, PONTANI, LIEBERMAN & PAVANE, 551 FIFTH AVENUE, SUITE 1210, NEW YORK, NY, 10176, US

(21) Appl. No.: 10/751,058

(22) Filed: Dec. 31, 2003

(51) Int. Cl. G01C 21/00

(52) U.S. Cl. 701/207; 701/213

(57) ABSTRACT

A method and apparatus for taking, transmitting, storing, processing, distributing and using data indicative of the position of a mobile object on the Earth's surface. More specifically, the latitude, longitude and altitude for the current position of a mobile object is measured, and the data for that position is periodically transmitted along with ancillary information to a central base station for persistent storage of the data in a server. Such stored data is thus available on past and current positions of the mobile object for use by various computer applications to derive information about the object's movements.

### FIELD OF THE INVENTION

The present invention relates generally to a method and apparatus for taking, transmitting, storing, processing, distributing and using data indicative of the position of a mobile object on the Earth's surface. More specifically, it relates to a technique for taking, or obtaining, the current latitude, longitude and altitude of a mobile object and periodically transmitting that data and ancillary information to a central base station for persistent storage of the data in a server, where an Application Programmers' Interface makes information available on past and present positions of the object for use by various computer applications.

### BACKGROUND OF THE INVENTION

Tracking the position of a mobile object (e.g., people, cars, pets) on the Earth's surface at any given time is desirable for any one of numerous, well-known reasons. A number of techniques have been developed to satisfy this need. Perhaps two of the best known techniques involve the global positioning system (GPS) and mobile telephones that are part of a cellular telecommunications network. GPS uses transmitters carried by orbiting satellites. A receiver mounted on the object being tracked polls the signals transmitted by the satellite to calculate its distance from that satellite. The receiver applies triangulation by detecting signals from three or more GPS satellites to determine its latitude and longitude on the Earth's surface, or from four or more GPS satellites to determine its latitude, longitude and altitude. In a cellular telecommunications network, the entire service area covered by the network is divided into a plurality of coverage areas called “cells”. The approximate position of a mobile telephone is known because the “cell” in which it is located is known. Moreover, various techniques have been developed to obtain a more precise measurement by determining the object's position within the cell.

A feature common to these known tracking techniques is that the information of interest is the object's current position. After the current position is determined and immediate use is made of that information, further need for it no longer exists. Consequently, the position data is not stored for a substantial period of time (i.e. no persistent storage of the data). Also, the position of the object is of interest at one particular time, but the next time that the object's position may be needed is typically quite a while later. Thus, data on where the object is located is not collected at closely spaced time intervals, nor is such sequentially collected position data stored. Consequently, although tracking an object to determine its present position to serve some useful function is well known, the prior art approaches are of limited value when information is required which is based on a history of the object's positions over a substantial period of time. The prior art does not collect (i.e. take and store) such history of object position data collected at closely spaced time intervals nor does it process such position data in order to facilitate the use of the stored data by programmers for various computer applications.

### SUMMARY OF THE INVENTION

One aim of the present invention is to obtain data about the position of a mobile object on the Earth's surface and to store such position data for a substantial period of time (i.e. persistent storage of the position data).

Another aim of the present invention is to automatically obtain, at closely spaced time intervals, a history of position data for where the object has been, and to store all such position data.

A further aim of the present invention is to process such position data taken at closely spaced time intervals in order to facilitate the task of using the stored data to provide requested information.

One other aim of the present invention is to provide a new method and apparatus for obtaining, transmitting, storing, processing, distributing and using the position data.

Still another aim of the present invention is to enable a faster, more reliable, more extensible, and more secure method of providing information about an object's whereabouts and motion history.

These and other aims are attained in accordance with one aspect of the present invention directed to a technique for providing information about movement of a mobile object to each of a plurality of positions along the Earth's surface. Position data related to each of the plurality of positions is obtained, and the position data for the plurality of positions is stored in a persistent database for selective retrieval therefrom upon request to provide information about movement of the mobile object.

Another aspect of the present invention is directed to a technique for providing information about movement of a mobile object to each of a plurality of positions along the Earth's surface. Position data related to each of the plurality of positions is collected in a persistent database. Responsive to a request related to a specified time and/or position, information is provided about movement of the mobile object corresponding to the specified time and/or position by accessing the position data for the plurality of positions stored in the persistent database.

Yet another aspect of the present invention is directed to a technique for providing information about movement of a mobile object to each of a plurality of positions along the Earth's surface by obtaining position data related to each of the plurality of positions. The position data for the plurality of positions is partitioned into a plurality of clusters of related positions that are accessible to provide information in response to a request.

Still another aspect of the present invention is directed to a technique for providing information about movement of a mobile object to each of a plurality of positions along the Earth's surface by obtaining position data related to each of the plurality of positions and deriving, based on the position data, an individual map for each of a plurality of the positions. Animating the movement of the mobile object is achieved by combining a plurality of said individual maps.

### BRIEF DESCRIPTION OF THE DRAWINGS

FIG. 1 shows a schematic block diagram of components arranged for implementing the invention.

FIG. 2 depicts a flowchart illustrating operations performed by the server in accordance with the present invention.

FIG. 3 provides details of the LOGIN operation shown in FIG. 2.

FIG. 4 provides details of the LOGOUT operation shown in FIG. 2.

FIGS. 5A-5C provide details of the LOCATION operation shown in FIG. 2.

FIG. 6 provides details of the DISTANCE operation shown in FIG. 2.

FIGS. 7A-7C provide details of the HISTORY operation shown in FIG. 2.

FIGS. 8A-8B provide details of the MAP operation shown in FIG. 2.

FIG. 9 provides details of the ANIMATION operation shown in FIG. 2.

FIG. 10 provides details of the PROXIMITY operation shown in FIG. 2.

FIG. 11A provides details of the OBSERVATION operation shown in FIG. 2.

FIG. 11B shows a convex hull and a bounding box.

FIGS. 12A and 12B show Tables 1 to 3B of information stored in the server and derived from location data related to motion of a mobile object on the Earth's surface.

### DETAILED DESCRIPTION OF THE DRAWINGS

Terms used in the explanation of the invention as presented herein are defined as follows:
Position: A three-dimensional geographic spot relative to the Earth's surface having a corresponding datapoint, which is a set of latitude/longitude/altitude data.
Observations: a sequential numbering of the positions obtained for a particular portable device attached to an object.
Location: a region of positions (which might be a single position, a cluster, a street address, a city, a convex hull, etc.)

The present invention is organized in a server-client configuration. Clients can be either hardware or software, and can provide data about an object's location, request information about an object's location, or both. The server stores the location data for multiple objects simultaneously, and processes that data into information readily usable by computer applications from clients that request information from the server.

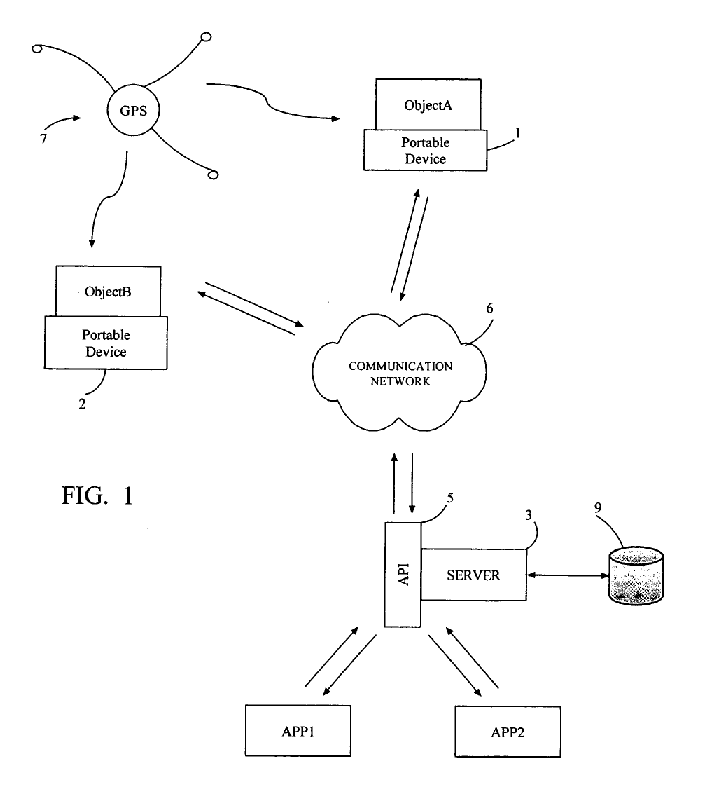

FIG. 1 shows one implementation of the invention using GPS technology. It should be understood that the invention is not restricted to GPS technology, and this particular arrangement is merely illustrative. The server 3 is arranged to operate with one type of client, namely portable device 1 on ObjectA and portable device 2 on ObjectB, as well as with another type of client, namely computer applications APP1 and APP2. The first type of client provides data to server 3 via API 5 about an object's position, as explained below. The second type of client requests information about the object's position from server 3 through API 5, as also explained below.

It should be understood that the number of clients, such as mobile objects, usable with this invention is a matter of design choice. The fact that just two objects are shown is done only for the sake of clarity in describing the invention while making the point that use of a plurality of objects is possible. In the ensuing description, only one object and its associated portable device will be discussed in detail, but it should be appreciated that such discussion applies to all objects and their associated portable devices. Likewise, it should be readily understood that the number of other types of clients, such as computer applications, usable with this invention is also a matter of design choice, and that only two are shown is done for the sake of clarity in describing the invention while making the point that a plurality of such applications is possible.

Turning now to FIG. 1, it shows an object (including, but not limited to, people, cars, and pets) that carries or encloses a position-gathering portable device (the “client”). The portable device (referred to below as “device”) can be placed, for example, inside a car or piece of luggage, or attached to a bicycle, or carried on one's person. The device includes well known circuitry (not shown) to poll signals from a plurality of GPS satellites 7 and to determine therefrom the position of the device on the Earth's surface (which, of course, includes multi-story buildings, tall tress, and the like) and, by inference, the object's position as well. The position data generated by the device identifies the object's specific position (i.e., by latitude, longitude and altitude) at a particular instant of time. The time data used in the invention (as detailed below) is generated by the device based on time information which is continuously transmitted by GPS satellites (and cell towers). The device also includes control circuitry (not shown) to automatically trigger at a preselected time interval the sequence of steps for detecting the GPS signals and for determining the object's position. Such preselected time interval is also a matter of design choice which trades off the resolution of the object's position as a function of time against the required data storage and battery life. The control circuitry can be designed to transmit the position data immediately to the server 3, or to store the position data for a predetermined number of positions and then to transmit the data for all such positions as part of a batch transmission. In the preferred embodiment, the device transmits a batch message over the air at periodic intervals to the server 3 which is equipped with a suitable database 9. The message is a digital encoding of a series of positions.

In a preferred embodiment, the portable device is a Nextel i88s or i95s mobile phone in which the above-mentioned control circuit runs a software program implemented in the J2ME programming environment. This program polls the GPS satellites to determine the current position data by calculating the current latitude, longitude and altitude of the object, and stores the position data locally (i.e. in the phone's memory). In accordance with the program, the device periodically relays the position data and the device's globally unique identifier (“GUID”), which was pre-stored therein, to a remote server via a communications network 6. After the position data has been sent (and if the TCP protocol is used, for example, after the server has acknowledged its receipt), the locally stored position data is deleted, and these steps are repeated. In addition, it determines the value of several other parameters, including the accuracy of the position calculation, the speed and heading of the object, and the number of GPS satellites “in view” at the time of the poll. A list of the stored parameters is as follows:
GUID
latitude
longitude
time of current observation
latitude/longitude accuracy
last observation time
last latitude
last longitude
cell latitude
cell longitude
speed
speed uncertainty
heading
altitude
altitude uncertainty
number of satellites
whether assisted GPS was used.

For purposes of this invention, a discussion involving only use of the GUID, time, latitude, longitude and altitude parameters is necessary. Therefore, no details of the other parameters is deemed necessary.

The program stores the current position data in the phone's memory, and periodically compresses (using a run-length-encoding algorithm) and then transmits the data to the server via communications network 6 using GPRS (Generalized Packet Radio Service—details of which are available at http)://www.gsmworld.com). The J2ME program provides menus that allow the user (i.e. the owner of the device) to control the frequency of GPS polls and how often they are relayed to the server, and whether the protocol is UDP or TCP.

The server 3 is a computer running the Linux operating system and a MySQL database engine 9 (available for free at http://www.mysql.com) which records in a persistent storage the attributes of each position, including the GUID, the time, the latitude, the longitude, and the altitude. This position data for a plurality of positions is raw data which represents the object's movements, and such raw data is preferably permanently stored in an appropriate persistent storage medium 9 such as magnetic disks, optical disks, or non-volatile RAM. The raw data is transformed in accordance with the invention, as explained below, into more readily usable information accessible via API 5.

An explanation of API 5 will now be provided. The API is the interface allowing access to the position data stored in the server to external computer applications. The interface handles requests from such external computer applications via the XML-RPC protocol. The server handles requests using the Perl RPC::XML::Server module. Client applications may use any XML-RPC implementation, such as the Perl RPC::XML::Client module.

The parameters are defined using the following definitions, in extended Backus-Naur form which is described in the book “Compilers: Principles, Techniques, and Tools”, by Alfred V. Aho, Ravi Sethi, and Jeffrey D. Ullman, Addison Wesley, 1986. Vertical bars separate alternatives, asterisks mean “zero or more times”, and plus signs mean “one or more times”.

OBJECT ::= (GUID|LOCATION|HULL)
LOCATION_TYPE ::= ( “street address”|“street”|“postal code”|“city”|
“state”|“country”|“cluster”|“mark”|“position” )
MAP_TYPE ::= ( “street”|“terrain”|“satellite” )
PLOT_TYPE ::= ( “point”|“trail”|“stipple”|“vector” )
GUID ::= HEXDIGIT+
SESSION ::= HEXDIGIT+
LOCATION ::= ( COUNTRY|STATE|POSTAL_CODE|CITY|
ADDRESS )
ADDRESS ::= STREET_ADDRESS [URBANIZATION] CITY STATE
[POSTAL_CODE] COUNTRY
STREET_ADDRESS ::= NAME
HULL ::= POSITION+
POSITION ::= LATITUDE LONGITUDE ALTITUDE
LATITUDE ::= [ “-” ] NONZERO_DIGIT [DIGIT] [DIGIT] [ “.”
DIGIT* ]
LONGITUDE ::= [ “-” ] NONZERO_DIGIT [DIGIT] [DIGIT] [ “.”
DIGIT* ]
ALTITUDE ::= [ “-” ] DIGIT* [ “.” DIGIT* ]
INTERPOLATION ::= BOOLEAN
STREAM ::= BOOLEAN
SORT_METHOD ::= ( “chronological”|“reverse_chronological”|
“ascending”|“descending” )
START_TIME ::= TIME
END_TIME ::= TIME
DURATION ::= TIME
TIME ::= NONZERO_DIGIT DIGIT*
TIME_STEP ::= NONZERO_DIGIT DIGIT*
FRAME_RATE ::= NONZERO_DIGIT DIGIT*
COUNTRY ::= NAME
STATE ::= NAME
POSTAL_CODE ::= NAME
CITY ::= NAME
PASSPHRASE ::= NAME
NAME ::= ( LETTER|DIGIT|“ ” )+
IDENTIFIER ::= ( LETTER|DIGIT )+
HEXDIGIT ::= ( DIGIT|“A”|“B”|“C”|“D”|“E”|“F” )
LETTER ::= ( “A”|“B”|“C”|“D”|“E”|“F”|“G”|“H”|“I”|“J”|“K”|“L”|“M”|
“N”|“O”|“P”|“Q”|“R”|“S”|“T”|“U”|“V”|“W”|“X”|“Y”|“Z”|“a”|“b”|“c”|
“d”|“e”|“f”|“g”|“h”|“i”|“j”|“k”|“l”|“m”|“n”|“o”|“p”|“q”|“r”|“s”|“t”|“u”
|“v”|“w”|“x”|“y”|“z” )
DIGIT ::= ( “0”|NONZERO_DIGIT )
NONZERO_DIGIT ::= ( “1”|“2”|“3”|“4”|“5”|“6”“7”|“8”|“9” )
BOOLEAN ::= ( “0”|“1” )

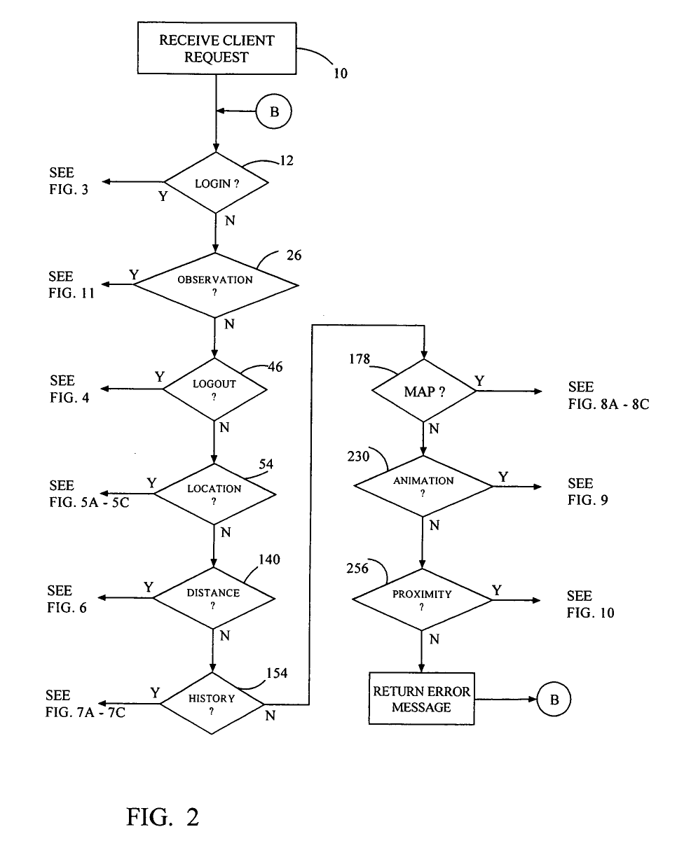

FIG. 2 is a flowchart which is useful to explain the operations performed by the server 3 in accordance with the present invention. Each of the clients transmits a request which is received by the server via API 5, per step 10. The server proceeds to determine which request has been received, and to respond appropriately. In the following discussion, the initial mention of an operation will specify within brackets the parameters that it utilizes. Optional parameters are within square brackets.

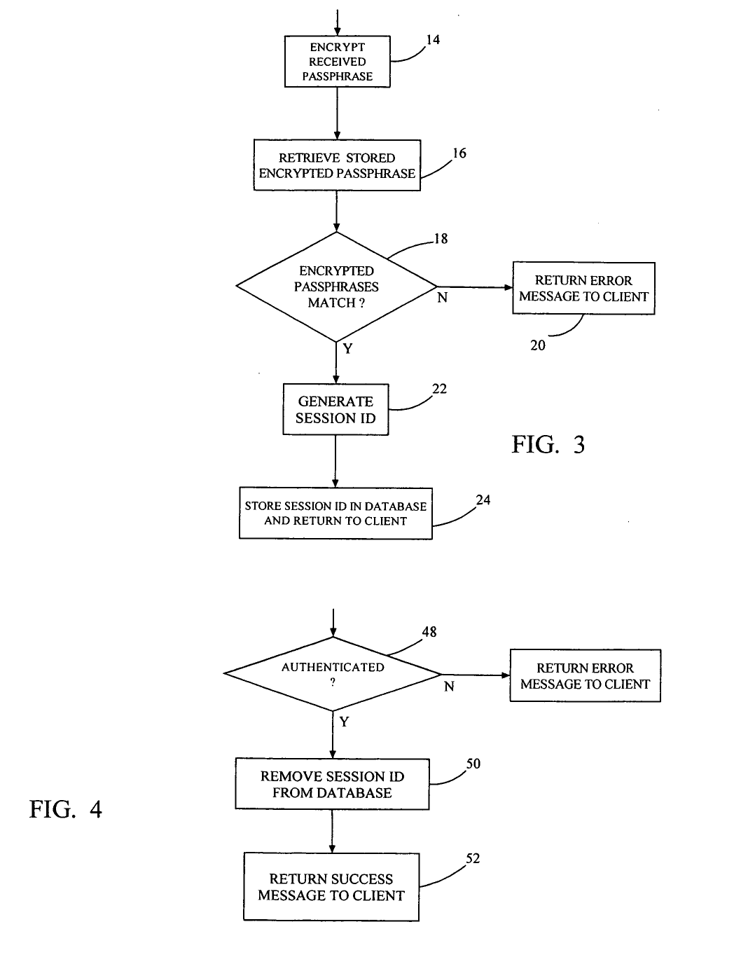

In order for a client to communicate with server 3, a LOGIN request 12 {[LOGIN (GUID, PASSPHRASE)]} is processed. This operation handles application requests based on the client's GUID and a pre-assigned PASSPHRASE. As shown in FIG. 3, the server receives, per 14, an encrypted PASSPHRASE entered by the user. A PASSPHRASE which has been pre-stored in the server for that GUID is retrieved, per 16, and is compared with the received PASSPHRASE, per 18. If they do not match, then a suitable error message is returned (i.e. transmitted) to the device, per 20. If they do match, then the server generates a code, called a SESSION ID, which is unique to the current session, per 22. The SESSION ID is stored in the server and also returned to the client, per 24, so that it becomes known to the client for later entry, as and when subsequently needed for authenticating other client requests, as explained below.

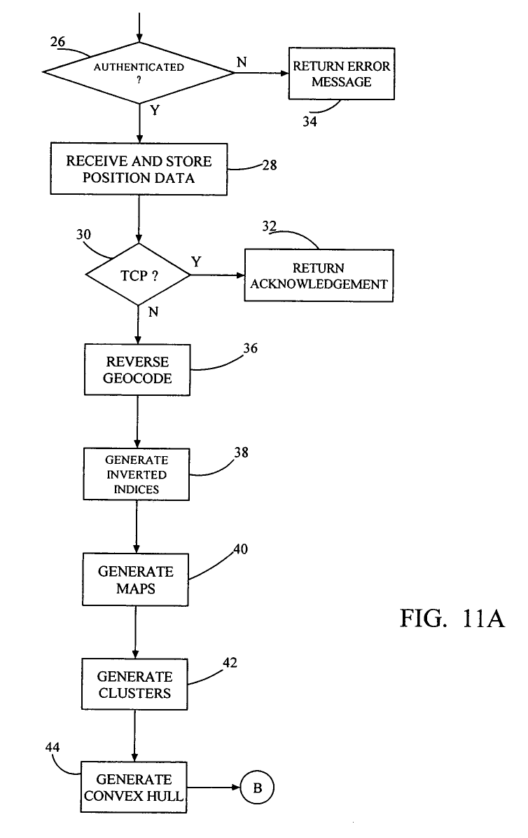

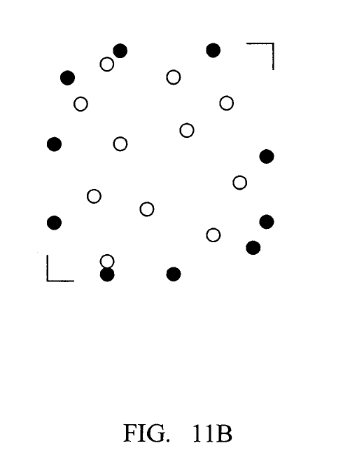

Another request that the server can handle is OBSERVATION request 26, the details of which are shown in FIG. 11A. The response to an OBSERVATION request processes the raw position data received from the device. It begins with authenticating the user, per 26, based on whether the SESSION ID received from the device matches the SESSION ID stored in the server. If the authentication is successful, then the server receives and stores the raw data, per 28. If it is determined, per 30, that the TCP protocol is being used for the transmission from the device, then the server returns an acknowledgement to the device, per 32. If another protocol is being used, such as UDP, then no acknowledgement is needed. Of course, if authentication 26 fails, then an appropriate error message is returned to the device, per 34.

The raw position data, as explained above, is stored per step 28 so that each datapoint of raw position data identifies a specific position (i.e. by its latitude, longitude and altitude at a particular instant of time), but this data is not readily usable by computer applications without considerable processing. In order to be in a more readily usable form, the position data is converted to location information specifying a three-dimensional region of the Earth's surface (e.g., a street intersection or a city). As will be explained below in greater detail, some position data is converted into a full street address specified by, for example, street name, house number, city, state and so on.

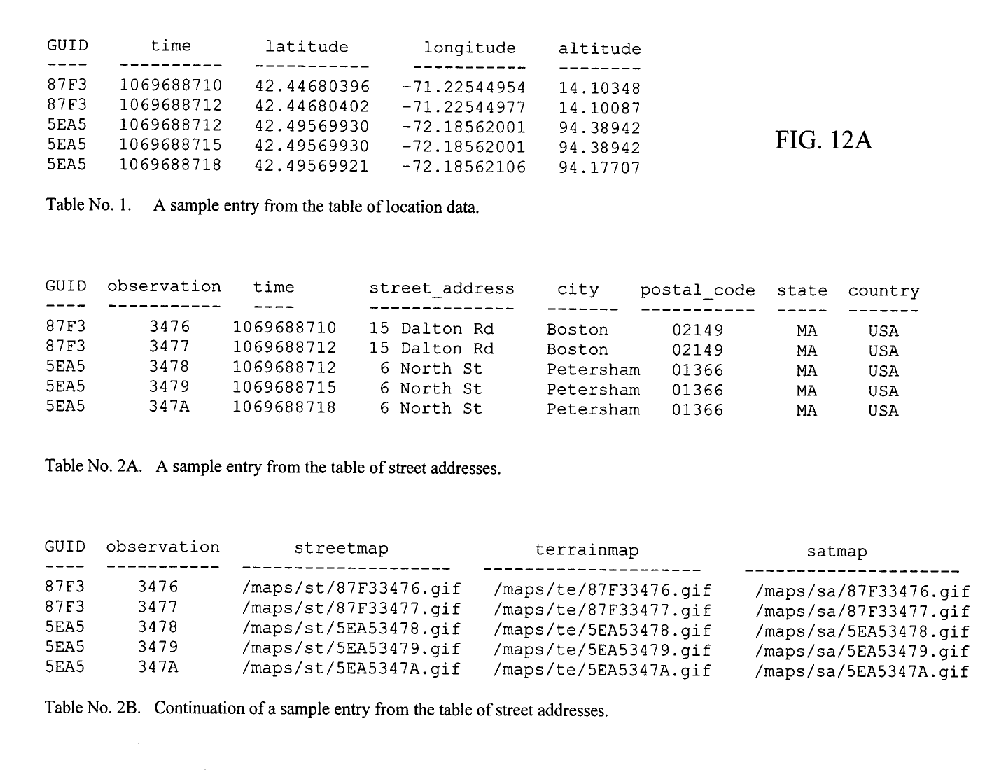

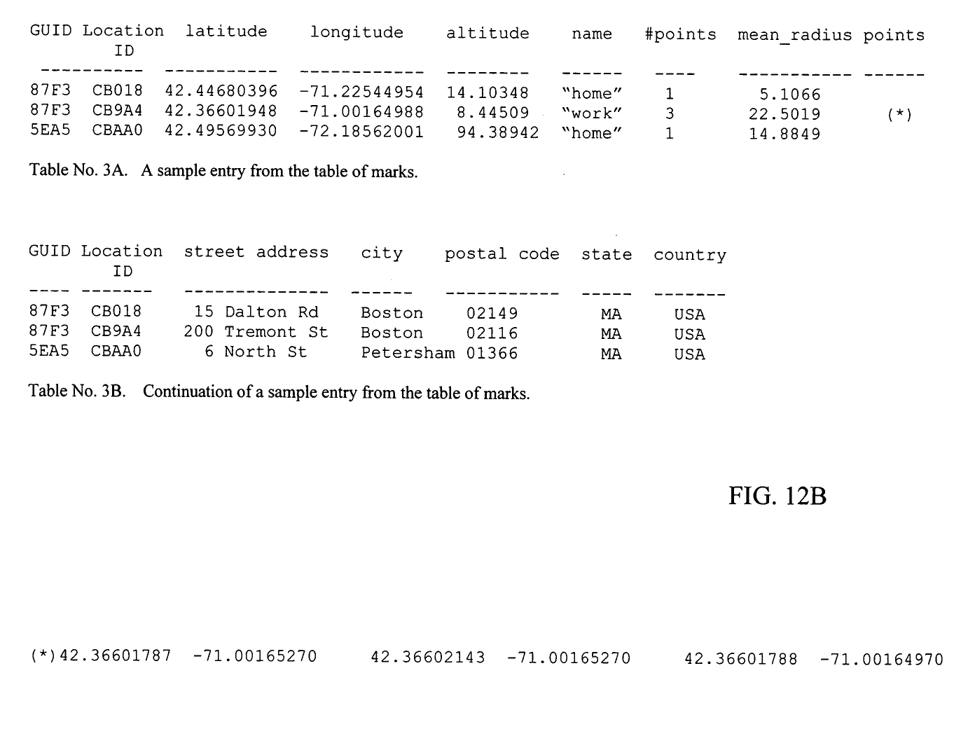

A sample entry from the table of raw position data stored in server 3 (actually in database 9) is shown in Table No. 1 of FIG. 12A. Hexadecimal notation (base 16) is used except in the time, latitude, longitude and altitude fields. The GUID 87F3 uniquely identifies the client which, in one example, can be device 1 carried by ObjectA. The data entered in the “time” field is the number of seconds counted from Jan. 1, 1970. Of course, other time indicators can be used as well. The latitude, longitude and altitude are self-explanatory.

Table 1 shows two observations for the object to which GUID 87F3 was assigned and three for the object to which GUID 5EA5 was assigned.

Step 36 of FIG. 11A converts the raw position data stored in step 28 to location information, such as street addresses. This process is known as reverse geocoding. A preferred software product to perform reverse geocoding is called SpatialFX, available from ObjectFX Corp. Several web services also perform reverse geocoding. A sample entry of stored data is shown in Tables 2A and 2B of FIG. 12A. (Table 2 has been separated into tables 2A and 2B of FIG. 12A due to space restrictions on the typewritten page. Table 2B is shown to include a repetition of fields “GUID” and “observation” only to show its link to the data in Table 2A). The “observations” field is an identifier indicating the sequence of the observations. It could be deduced from the time field, but explicitly including it in the table makes certain common calculations easier, e.g., a request by the user such as “show me the last 100 positions of my car.” The other fields in Table 2A are self-explanatory from the field headings. The fields in Table 2B are discussed in detail below. The result is a table in the database that enables computer applications to efficiently query the location of an object and have it returned as the closest street address, as explained below.

Step 38 converts the addresses obtained per 36 to several inverted indices. For example, one inverted index converts a full street address to all the observed positions which step 36 had converted into such address. This is done for every address. Thus, if a user wants to know “when was the last time I was at [address]?” the answer can be quickly and efficiently produced from the inverted index. Without the inverted index, the server would need to process through all the stored position data in database 9. Similar reverse indices are made for city, postal code, state and country.

An address is derived by step 36 for each observed position. Likewise, an entry in the inverted index is created for each address from step 36. However, entries corresponding only to an observation is preferably deleted after an hour.

Step 40 converts each street address obtained per step 36 to a street map which shows the vicinity of the street address. This is accomplished using a product such as MapPoint, from Microsoft, Inc. Street maps for all key locations (e.g. those assigned a Location ID by the server, as explained below) are kept permanently. Street maps for non-key locations are preferably deleted after an hour to conserve space in the memory. This information is stored in the “streetmap” field of Table 2B in FIG. 12A. It constitutes a path to where such map is stored in the database, which enables computer applications to efficiently generate a street map of an object's location.

Such a street map can have numerous uses. For example, a user may attach device 1 to his dog. If the user wishes to know where his dog is, the invention can generate (as explained below) a street map showing where to find the dog. For another example, if the device 1 is attached to the user, he can give someone else directions to wherever he currently is located by using the invention to generate a street map that the user can then send electronically to the other person.

Step 40 also converts the raw position data stored per step 28 to satellite maps. This is accomplished using a product such as EarthViewer, from Keyhole, Inc. This information is stored in the “satmap” field of Table 2B in FIG. 12A. It constitutes a path to where such map is stored, which enables computer applications to efficiently generate a satellite map of an object's location. For example, if the user wants to get a “bird's eye” sense of what the area of interest looks like, the invention could be used to generate a satellite map. Street maps can provide two-dimensional assistance on where to turn left and right, but satellite maps are three-dimensional and show far more detail on, for example, what the area of interest looks like, and what the buildings around it look like, and how wide the streets are.

In response to ANIMATION request 230, the invention can also generate an “animated” street map, terrain map and/or satellite map, which is a video that shows motion of the object by superimposing the object's motion on, respectively, a street, terrain and/or satellite, map.

Step 40 also converts the raw position data stored per step 28 to terrain maps. This is accomplished using a product such as MapServer, from Maptech, Inc. This information is stored in the “terrainmap” field of Table 2B in FIG. 12A. It constitutes a path to where such map is stored, which enables computer applications to efficiently generate a terrain map of an object's location. For example, if the user were trapped on a mountain, the invention could be used to generate a terrain map which could be beamed with a mobile phone to rescuers. Terrain maps show the features of the landscape, providing clues that mere latitude, longitude and altitude do not.

Step 42 converts the raw position data stored in step 28 to clustered positions. Because every location technology has some inherent inaccuracy, including GPS, position measurements will often fluctuate around the object's true position. Furthermore, a meaningful location (such as a street address) is often not a sharply defined boundary. To remedy these problems, and to determine important areas, nearby positions are grouped together and treated, respectively, as a single geographic location. The technique of identifying positions that deserve to be grouped together is called clustering, and the present invention accomplishes this using an ISODATA clustering algorithm. This algorithm is disclosed in Therrien, C. W. “Decision, Estimation and Classification”, John Wiley & Sons, 1999, and the explanation of this algorithm which is contained therein is hereby incorporated by reference. The result is a table (discussed in detail below) in the database that enables applications to efficiently determine the frequently-visited locations of an object. A sample entry obtained by clustering is shown in Table No. 3 of FIG. 12B. (Table No. 3 has been separated into tables 3A and 3B of FIG. 12B due to space restrictions on the typewritten page. Table 3B is shown to include a repetition of the fields “GUID” and “Location ID” only to show its link to the data in Table 3A). A Location ID is assigned by the server to the following regions: cluster, street address, city, postal code, state, country, and any position specifically designated by a client (along with an assigned radius).

Pre-processing and post-processing steps for ISODATA are required to take into account the fact that the Earth is approximately spherical. Every degree of latitude is the same distance, but not so for longitude. The geographic distance of one degree of longitude is greater at the equator than at the poles. For instance, at the North Pole, one can move through 360° of longitude just by pivoting, while at the equator one must travel around the circumference of the Earth to cover 360° of longitude. Without the pre- and post-processing steps, the results would be far less accurate, especially if motion of the object covered large north-south distances.

So, the pre-processing step is applied to “warp” latitude and longitude to the Universal Transverse Mercator coordinate system (which doesn't suffer from this nonlinearity caused by longitude) and use that as input to ISODATA. The post-processing step is to unwarp, i.e. to convert the Universal Transverse Mercator positions back into latitude and longitude. The conversions between lat/long and Universal Transverse Mercator are straightforward. Information on how to do this is available at http://www.uwgb.edu/dutchs/UsefulData/UTMFormulas.HTM, which has printed references at the end of the page.

ISODATA processes the position data for a (potentially large) number of positions, and partitions them into clusters. The result is a set of points (from which a convex hull is computed as explained below) and a centroid. As is evident from FIG. 11A, clustering is performed for each new datapoint. However, if this creates a high processing load, then the clustering algorithm is performed only at selected time intervals, such as every hour.

As has just been explained, clustering step 42 determines the positions grouped into a cluster. The convex hull algorithm 44 then determines the minimum number of points to define the location of that cluster. For example, if there are 50,000 observations peppered in and around a user's house, clustering (via the ISODATA algorithm) groups all of those positions into one cluster. The convex hull algorithm identifies the positions at the boundary of that cluster. More specifically, step 44 determines a boundary from the raw position data stored in step 28 for the positions partitioned into one cluster, so that all of the positions are within or on the boundary. Of course, there is likely to be a different boundary for each different cluster. An intuitive explanation of a convex hull algorithm can be provided as follows. If a large number of nails were hammered into a board at random, and then a rubber band were stretched around all of the nails, some nails will be inside the rubber band, and others will be touching the rubber band. The nails touching the rubber band constitute the convex hull. A mathematical definition of this term is that a “convex hull” is a minimal convex subset containing a set of objects. FIG. 11B shows the convex hull as black circles, and the white circles indicate positions inside the convex hull.

A convex hull is preferably generated with the Perl subroutine described in Orwant et al., “Mastering Algorithms with Perl”, O'Reilly & Associates, 1999, p. 454, which is hereby incorporated by reference, with the modification that once a convex hull has been stored for an object, it can be iteratively expanded or contracted as each new datapoint arrives. As is evident from FIG. 11A, convex hull is performed for every new datapoint. However, if this creates a high processing load, then the convex hull algorithm is performed only at selected time intervals, such as every hour.

The datapoints defining the convex hull are stored as ordered pairs (i.e. latitude and longitude) in the “points” field in Table No. 3A depicted in FIG. 12B. If, for example, the cluster identified by the hexadecimal CB018 in the Location ID field has a convex hull which requires 15“nails” to define the shape of the “rubber band”, the “#points” field would have the number 15 in it, and the “points” field would have 15 ordered pairs corresponding, respectively, to these “nails”. As a specific illustrative example, Table 3A lists the hexadecimal CB018 as the Location ID for an object having 87F3 as its GUID. This cluster's centroid is determined to be at a latitude of 42.44680396, longitude of −71.22544954, and altitude of 14.10348. The convex hull algorithm has determined that this cluster's shape is a circle (which is evident from the entry of “1” in the “#points” field indicating that only one point, namely the centroid, plus the mean-radius of 5.1066, are required to defineits shape). In contrast, Location ID CB9A4 needs 3 positions (or points) to specify the shape of its convex hull, and the ordered pairs for these are found in the “points” field.

The position of the centroid for Location ID CB018, and therefore the location of the cluster, corresponds to an address at 15 Dalton Rd., Boston, Mass. 02149 USA which has been obtained from the result of step 36.

Once a convex hull is available, it is very easy computationally to determine whether a position is inside it. Convex hulls are specifically designed for this purpose. Of course, it is also possible to represent a cluster as a region enclosed/defined by an imaginary line that might not correspond to actual locations visited by the object.

Another request that the server can handle is LOGOUT request 46 {logout(SESSION)}. This is a request to terminate a session. As shown in FIG. 4, after authentication step 48 is successful, the stored SESSION ID is deleted from database 9, per 50, and a suitable success message is returned to the device, per 52. When the server receives a LOGOUT request for a session, it invalidates the client's SESSION ID, prohibiting other invocations thereof until the client logs in again.

Server 3 can also handle a LOCATION request 54 {location(SESSION, OBJECT, LOCATION_TYPE, [TIME], [INTERPOLATION])}. This operation handles application requests to determine the location of an object via the “location” method. The client provides a SESSION ID for authentication, specifies the object to be located, and designates a location type to specify a desired output format. Additionally, the client may also specify a desired time of the location observation, and a Boolean interpolation bit indicating whether the system should estimate the location of the object in an attempt to match the time as precisely as possible.

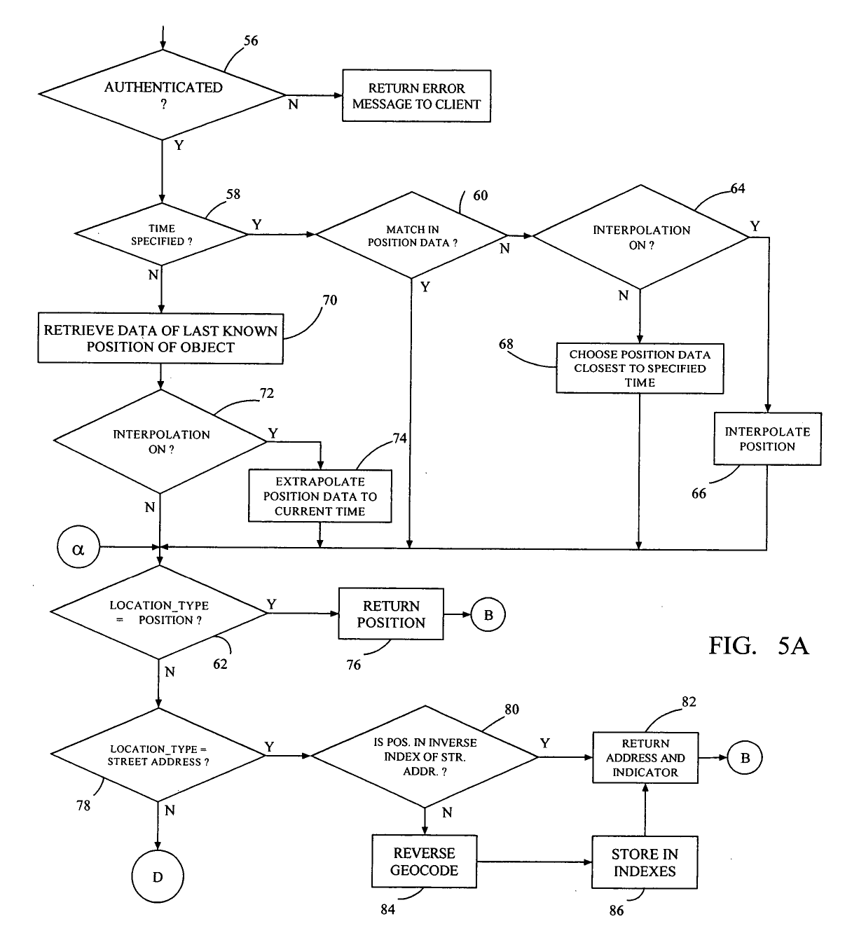

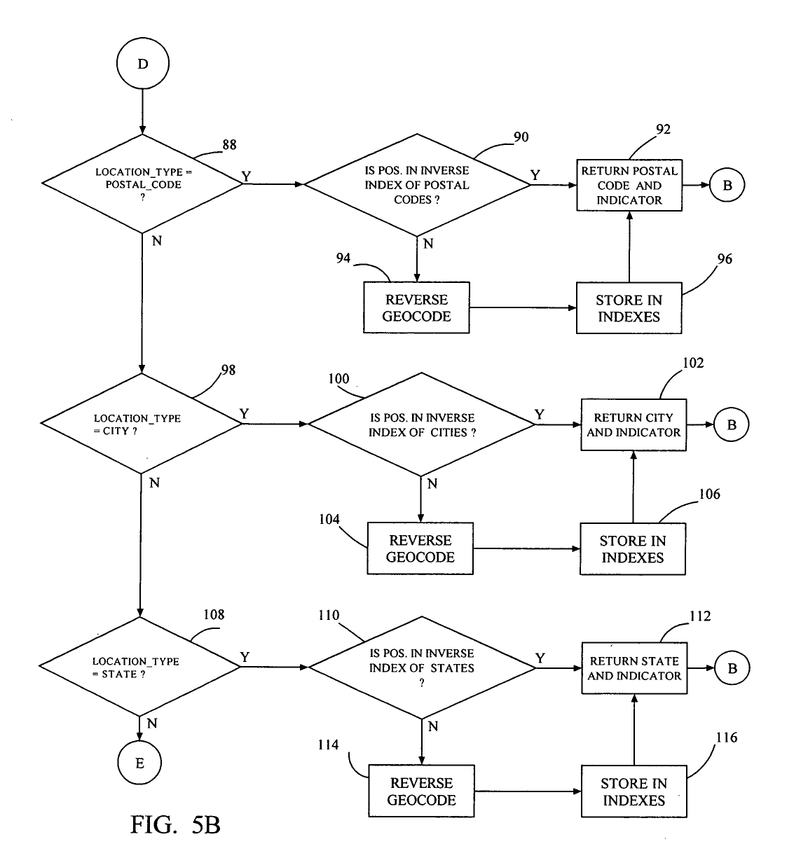

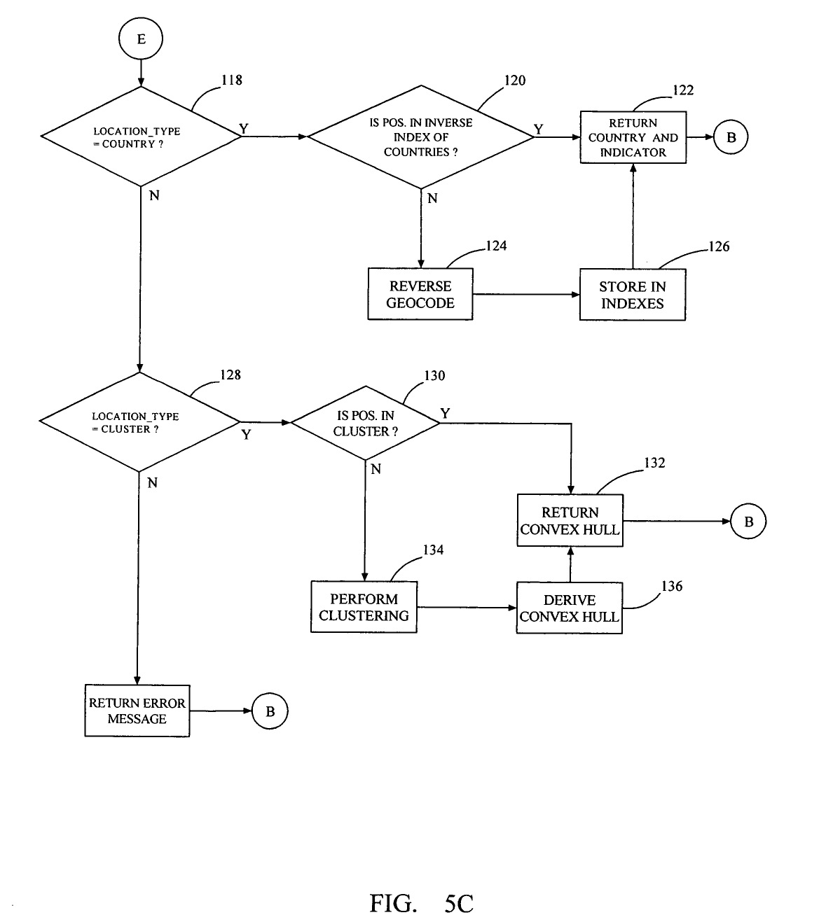

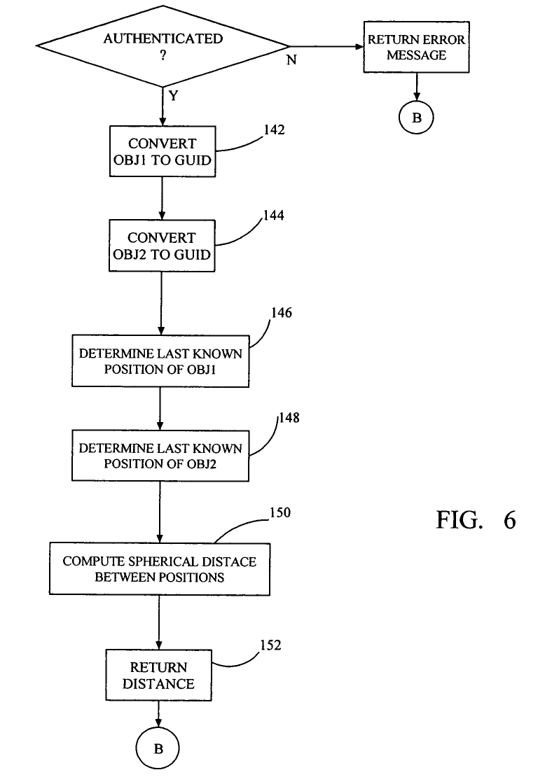

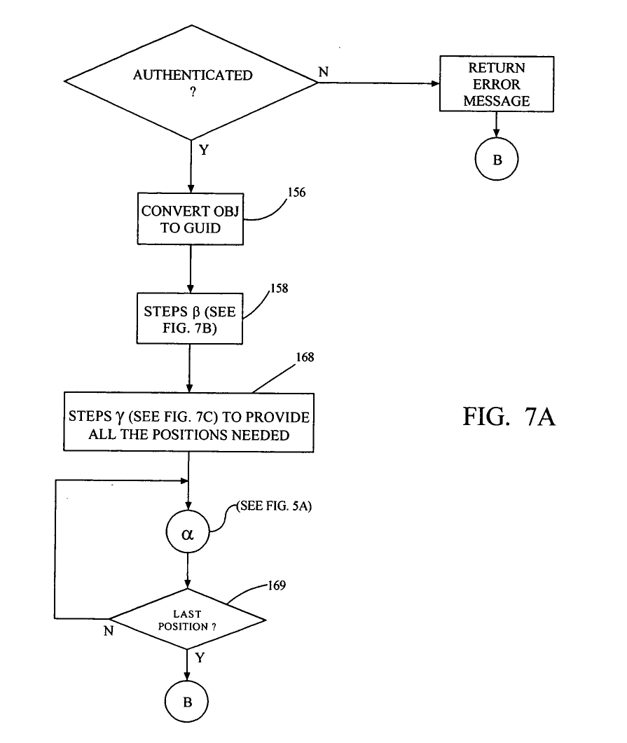

As shown in FIGS. 5A-5C, if authentication 56 is successful, step 58 checks whether the user is requesting the location at a specified time. If so, then step 60 checks whether the position data has the exact time. If so, then step 62 is performed (see below). If not, then step 64 checks whether interpolation is permitted. If so, then step 66 calculates the position interpolated between the two stored times in the database. If interpolation is OFF, then step 68 selects whichever the position data for whichever time is stored that is closest to the specified time.

If step 58 reveals that no time is specified, then step 70 retrieves the position data for the last known position. If interpolation is ON, per 72, then step 74 extrapolates the position to the current time. If interpolation is OFF, per 72, then the last known position data is simply used as is.

Thus, when the user requests a location, the input to step 62 is the position needed to respond to that request. Step 62 will determine whether the user wants this information in the form of raw position data. If so, that data is provided by step 76, and the flow then returns to the initial stage of request determination, as shown in FIG. 2. If not, then step 78 determines whether the location type is a street address. If so, then step 80 determines whether that street address is in the inverse index of street addresses obtained per step 38. If so, then step 82 provides that address to the user. If not, then the reverse geocoding process is run, per 84, the information is stored in the index for future availability, per 86, and returned to the user, per 82.

Steps 98, 100, 102, 104 and 106 for postal code correspond, respectively, to above-described steps 88, 90, 92, 94 and 96. Similarly, correspondence applies to 108, 110, 112, 114, 116 for state, and 118, 120, 122, 124 and 126 for country.

If the designated location type is a cluster, per 128, then step 130 determines whether the specified position is in an existing cluster. If so, the convex hull is returned, per 132. If not, then clustering is performed per 134, the convex hull algorithm is performed, per 136, and the result returned to the client, per 132.

Another request handled by the server is DISTANCE request 140 {distance(SESSION, OBJECT, OBJECT)}. The server handles application requests to determine the distance between two objects. The client provides a SESSION ID and two objects. The result is calculated by determining the decimal latitude and longitude of each object using the appropriate steps, and then computing the spherical distance (i.e. approximately the distance along the surface of the Earth) between the centroids of those locations.

As shown in FIG. 6, steps 142 and 144 retrieve from the database the respective GUIDs for the specified objects. Step 146 determines the last known position of the first object, and step 148 does likewise for the second object. Step 150 then computes the spherical distance therebetween. The result of the computation is transmitted to the client, per 152.

Another request handled by the server is HISTORY request 154 {history(SESSION, OBJECT, LOCATION_TYPE, [TIME_STEP], [INTERPOLATION], [START_TIME], [END_TIME])}. The server handles HISTORY requests to determine the movement history of an object. The client provides a SESSION ID, an object, a location type and, optionally, a time step, an interpolation bit, a start time, and an end time.

If a time step is provided, the server returns observations with a fixed period, e.g., locations on the hour. If the interpolation bit is set, estimates are used to determine the position at the given times. Otherwise, the closest actual observation is used. The result is returned as a series of timestamped observations. The observations begin at the start time if provided, and the first observation if not. The observations end at the end time if provided, and the last observation if not.

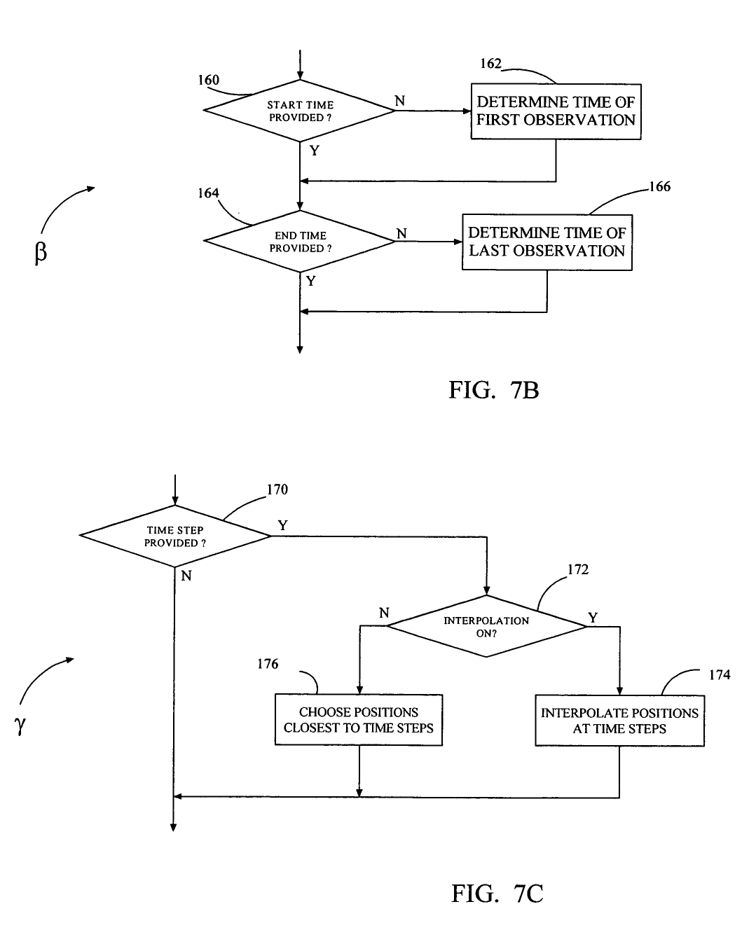

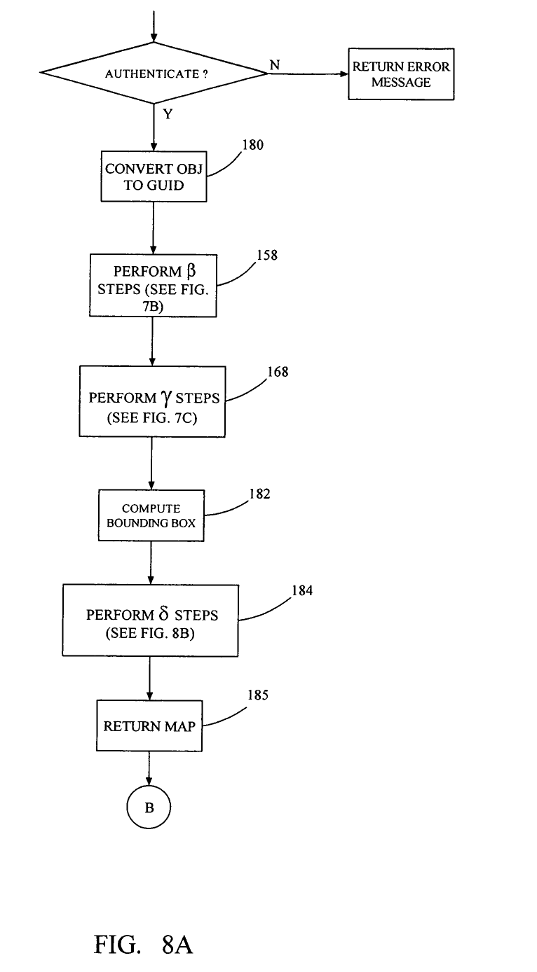

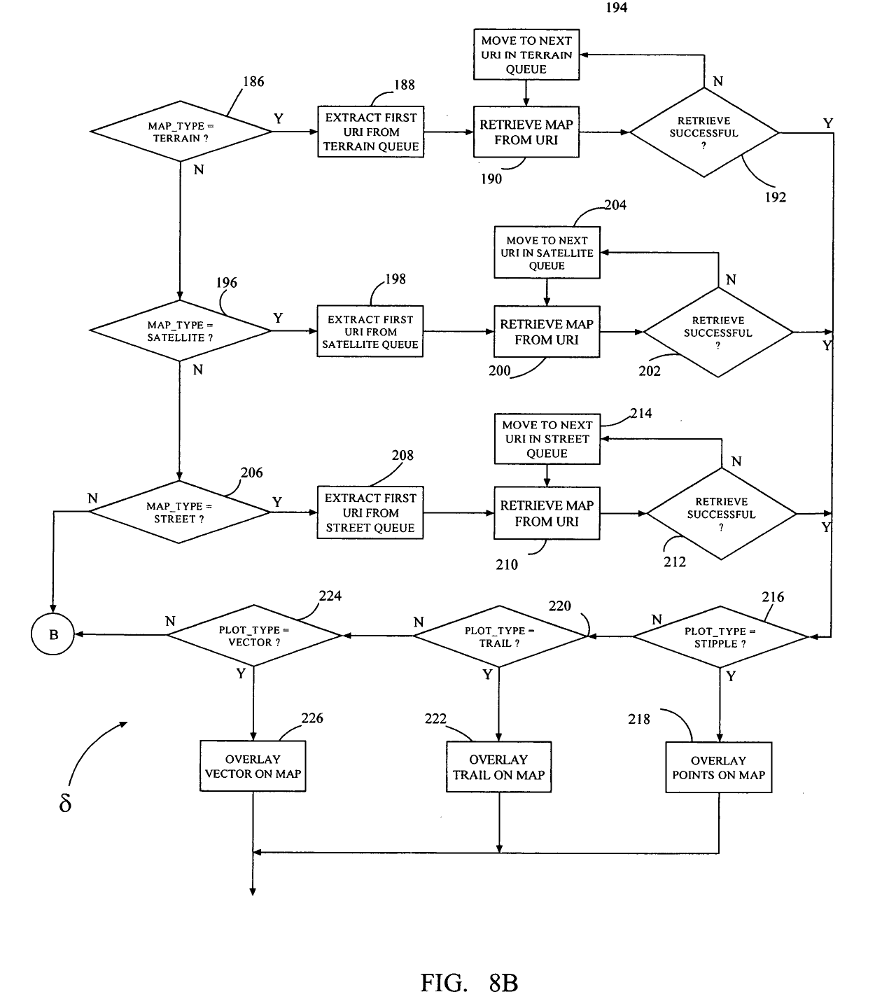

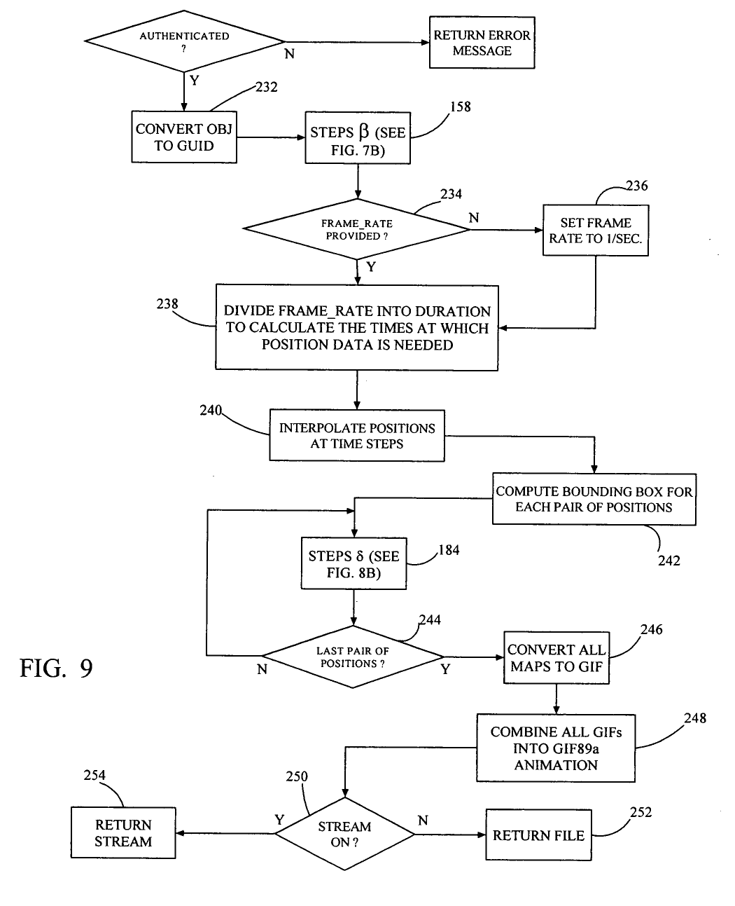

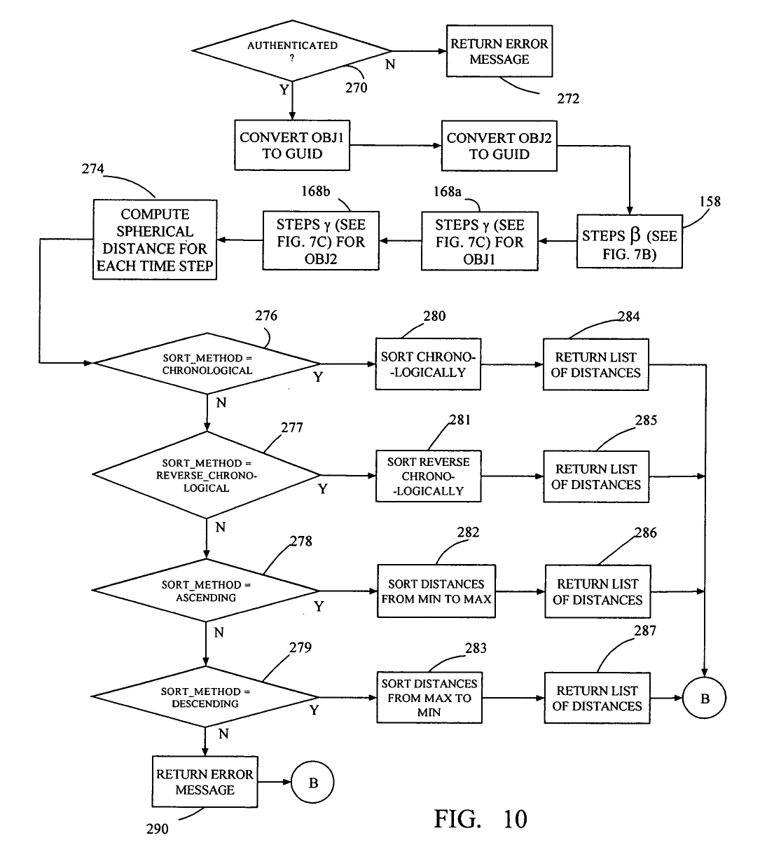

As shown in FIGS. 7A to 7C, after authentication is successful, step 156 determines the object's GUID. Then step 160 (see FIG. 7B) checks whether the client request specifies a start time. If not, then step 162 uses the first observation recorded for that object. Either way, step 164 then checks whether an end time has been provided. If not, then step 166 uses the last observation recorded for that object. So, at the end of steps 160-166, the start and end times needed for processing this HISTORY operation are known.

Then, step 170 (see FIG. 7C) checks whether the client request specifies a time step. If so, and if interpolation is ON, per step 172 (i.e. an interpolation bit has been provided), then step 174 interpolates between times that bracket time step. For example, if the time step is 5 minutes. However, if no position was detected at a 5 minute interval, but there is one at 4 mins. 32 secs. and another at 7 mins. 15 secs., step 174 will provide interpolated position data for the 5 min. interval using the data for such two positions. On the other hand, if interpolation is OFF, step 176 will select the position data obtained at 4 mins. 32 secs. Because that is closest to the time of the 5 min. interval.

Function 158 shown in FIG. 7A represents all the steps shown in FIG. 7B. Likewise, all the steps shown in FIG. 7C are represented by function 168 of FIG. 7B. At the conclusion of functions 158 and 168, a datapoint for a particular position is known from step 174 or 176, and is available for further processing in accordance with the HISTORY operation.

As shown in FIG. 7A, that known portion is inputted to step 62 in FIG. 5A. So, if the client request is for the movement to be provided as street addresses, that address will be determined by step 78, and the street address corresponding to the above-mentioned known position (i.e. from step 174 or 176) will be returned to the client by step 82.

This sequence of steps for the HISTORY operation follow a loop, per 169 (see FIG. 7A) until all the positions (i.e. up to the end time) have been processed.

Another request handled by server 3 is MAP request 178 {map(SESSION, OBJECT, MAP_TYPE, PLOT_TYPE, [START_TIME], [END_TIME], [INTERPOLATION])}. The server handles this request by generating a map of an object's location. The client provides a SESSION ID, an object, a map type, a plot type and, optionally, a start time, an end time, and an interpolation bit. The server retrieves a map from the database if available from Table 2B, and otherwise generates one.

The map type may be any one of “street”, “terrain”, or “satellite” types. The plot type is any one of “point”, “trail”, or “vector”, and it sets how the object's path is plotted in the generated map. If a start time is provided, locations of the object are used beginning at that time and, otherwise, the first observation recorded by the system. If an end time is provided, locations of the object are used ending at that time and, otherwise, the last observation recorded by the system. If the interpolation bit is set, the system fills in data between actual observations using a conventional interpolation algorithm. The map image is then returned to the client.

As shown in FIGS. 8A and 8B, after successful completion of the usual authentication step followed by conversion to a GUID, per 180, the steps of above-described function 158 determine the start time and end time, as explained above. Then, the steps of above-described function 168 determine an observed position to process, as explained above.

At this stage, the map being created needs to have a “bounding box” because map services (such as the above-mentioned MapPoint) need to know what to map. It is not sufficient to merely request a map at, say, 43 latitude, −71 longitude because the map service will not know the scale: should it be a square yard? a square mile? So, when a map service is used, which is the case for the present invention, a “bounding box” must be provided that defines the rectangular perimeter of the map.

The present invention computes the bounding box from the convex hull of a location by looping through all of the points in the hull, and calculating the minimum latitude, maximum latitude, minimum longitude, and maximum longitude. The bounding box is then a rectangle with its upper left corner at a point with minimum latitude and minimum longitude, and its lower right corner at a point with maximum latitude and maximum longitude. In FIG. 11B, the corner brackets indicate the bounding box relative to the convex hull.

Step 182 of FIG. 8A computes the bounding box in accordance with the algorithm described above.

Once the bounding box is computed, the MAP operation 178 proceeds to perform what is represented in FIG. 8A as function 184, the details of which are presented in FIG. 8B. Before turning to that drawing, it must be mentioned that the server maintains three queues of URIs (Uniform Resource Identifiers) for mapping services (one for street maps, one for terrain maps, and one for satellite maps). Each queue is arranged in order of observed reliability over the lifetime of the system (i.e. empirically, from the success or failure of previous attempts to use the mapping services). These queues are maintained in the event that one or more mapping services are unavailable. Thus, if one mapping service fails to respond, the server accesses the queue to select the next mapping service.

Step 186 determines whether the map type specified in the client request is a terrain map. If so, then step 188 proceeds to extract the first URI from the terrain queue, and the map is retrieved, per 190. If the retrieval is successful, per 192, then the information is overlayed on the requested plot type. Which plot type is to be used is determined per steps 216, 220 and 224, and then the appropriate one from among steps 218, 222 and 226 performs the map overlay. If the map retrieval is not successful, per step 192, then step 194 moves to the next URI in the queue and loops once again through steps 190 and 192.

Steps 196, 198, 200, 202 and 204 are performed for a satellite map, and they respectively correspond to above-described steps 186, 188, 190, 192 and 194.

Likewise, steps 206, 208, 210, 212 and 214 for a street map respectively correspond to above-described steps 186, 188, 190, 192 and 194.

URI extraction steps 188, 198 and 208 use a utility for extracting a map from the service named by the URI. One such utility is the Perl WWW::Mechanize module, available from http://search.cpan.org. The system uses the utility to retrieve a map with the bounding box computed in step 182, and the map is returned to the client per 185.

Another possible client request is ANIMATION request 230 {animation(SESSION, OBJECT, MAP_TYPE, PLOT_TYPE, DURATION, FRAME_RATE, [STREAM], [START_TIME], [END_TIME])}. This method handles application requests to generate an animation of the object's motion. The client provides a SESSION ID, an object, a map type, a plot type, a duration, a frame rate, and optionally a stream bit, a start time, and an end time. The first four parameters are as discussed in previous steps. The duration is the length of time that animation should last. The frame rate is the number of frames per second. The stream bit is a Boolean indicating whether the client wants to download the entire animation or receive it frame by frame as it is generated. The start time is the time of the first observation of the object. The end time is the time of the last observation of the object. The server determines a set of representative observations via bilinear interpolation, generates a map for each such observation, combines the sequence of maps into an animation, streaming the result to the client if the stream bit is set, and sending the entire animation otherwise.

As shown in FIG. 9, authentication and conversion to a GUID are first performed. Then, above-described function 158 is performed to determine the start and end times. Step 234 determines whether a frame rate is included in the client request. If not, then this parameter is set to 1 frame per second. The frame rate from 234 (if one is specified) or 236 (if one is not specified) is inputted to step 238 which determines the times at which observations are required for a smooth animation. This is done by dividing the value of the specified frame rate parameter (or 1 if the frame rate parameter was not specified) into the value of the DURATION parameter (or, if DURATION is omitted, the value of the end time parameter minus the value of the start time parameter, with end time defaulting to the last recorded observation, and start time default to the first recorded observation). Of course, DURATION refers to the desired length of time for the animation sequence. The result of this step is a sequence of equally-distributed times at which the position of the object should be appear in the animation.

Step 240 performs the necessary interpolation, and step 242 computes a bounding box for each pair of positions. Then, the derived information is used by above-described function 184 (see FIG. 8B) to create a map in the requested map type using the requested plot type.

Step 244 determines whether processing of the ANIMATION operation has reached the last pair of positions. If not, then processing of this operation repeatedly loops through function 184 until the last pair of positions is reached. It should be understood that at this stage, all the maps that were derived by looping through function 184 are individually stored locally at the server. Step 246 uses a utility to convert all those maps to a GIF image format. One such utility is pbmplus, available at http://www.acme.com/software/pbmplus/.

Then, step 248 uses a utility to combine the resulting GIF images into an animated gif with the frame rate specified in the frame rate parameter. One such utility is MultiGIF, available from http://www.kfs.org/˜abw/code/multigif.html. The result is the map animation, which is then transmitted back to the client.

The animation is returned to the client as files or a stream, based on steps 250, 252 and 254. The streaming can be accomplished using any conventional Internet video streaming technology, such as that provided by Quicktime (Apple, Inc.; http://developer.apple.com/quicktime) or RealVideo (RealNetworks, Inc.; http://www.real.com).

The final request shown on FIG. 2 is PROXIMITY 256 request {proximity(SESSION, OBJECT, OBJECT, SORT_METHOD, [START_TIME], [END_TIME], [TIME_STEP], [INTERPOLATION])}. This method handles application requests to generate a listing of distances between two objects. The client provides a SESSION ID, two objects, and an ordering of data which specifies distance or time, either forwards or backwards. The client may provide an optional start time, end time, time step, or interpolation bit, interpreted as in previous steps.

As shown in FIG. 10, the two objects are converted to their respective GUIDs by steps 270 and 272. Function 158 determines the start time and end time. Function 168a, having the same functions as above-described function 168, provides positions for the first object. Similarly, function 168b provides positions for the other object. Each step for this operation will have one position for the first object and one position for the second object. Step 274 computes the spherical distance between those positions of the two objects. This is then done for each time step. If the two objects are stationary, then the distance between them obviously will remain the same. If one object is moving and the other is stationary, the distance between the objects depends only on the moving object's motion. If both objects are moving, then the distance will vary in accordance with their combined motion.

Several sort methods are available for presenting the results of the PROXIMITY operation. The distance between the objects can be shown as a function of time in chronological order, or in reverse chronological order. Also, the result can be shown in terms of magnitude of the distance between the objects, with the distance being shown in ascending order, or in descending order. If the client request does not correspond to any of theses sort methods, then an error message is returned, per step 290.

Steps 276-279 determine which sort method has been included in the client request. Steps 280-283 respectively perform the requested sort method, and steps 284-287 return the requested information to the client.

Although a preferred embodiment of the present invention has been described above in detail, various modifications thereto will be ready apparent to anyone with ordinary skill in the art. For example, the present invention may be implemented either in hardware or software, or a combination of both. Also, the ISODATA algorithm is one of several techniques for defining a location. Other techniques are possible, such as fuzzy clustering, hierarchical clustering, and Kohonen's self-organizing maps. There are alternatives to use of GPRS, such as HSCSD and the 802.11 protocol family. Furthermore, rather than using MultiGIF, the maps in GIF format can be converted into a GIF89a animation by scripting a software product such as Ulead, available from http://www.ulead.com. Also, there are alternatives to the use of GPS as a location technology, such as Cell ID, Bluetooth, or RFID. These and all other such modifications are intended to fall within the scope of the present invention as defined by the following claims.

1. A method for providing information about movement of a mobile object to each of a plurality of positions along the Earth's surface, comprising:
obtaining position data related to each of the plurality of positions; and
storing the position data for the plurality of positions in a persistent database for selective retrieval therefrom upon request to provide information about movement of the mobile object.

2. The method of claim 1, wherein the position data for the plurality of positions is obtained automatically.

3. The method of claim 1, wherein the position data for the plurality of positions is related to position measurements made at periodic time intervals.

4. The method of claim 1, wherein the position data for the plurality of positions comprises latitude and longitude.

5. The method of claim 4, wherein the position data for the plurality of positions further comprises altitude.

6. The method of claim 1, wherein the request is based on time.

7. The method of claim 1, wherein the request is based on at least one of said plurality of positions.

8. The method of claim 1, wherein the storing step includes converting the postion data to location information related to at least one of said plurality of positions.

9. The method of claim 8, wherein said location information is at least one of street address, postal code, city, state and country.

10. A method for providing information about movement of a mobile object to each of a plurality of positions along the Earth's surface, comprising:
collecting in a persistent database position data related to each of the plurality of positions; and
responsive to a request related to a specified time and/or position, providing information about movement of the mobile object corresponding to the specified time and/or position by accessing the position data for the plurality of positions stored in said persistent database.

11. The method of claim 10, wherein the position data for the plurality of positions is collected automatically.

12. The method of claim 10, wherein the position data for the plurality of positions is constantly collected at periodic time intervals.

13. The method of claim 10, wherein the position data for the plurality of positions comprises latitude and longitude.

14. The method of claim 13, wherein the position data for the plurality of positions further comprises altitude.

15. The method of claim 10, wherein the step of accessing the position data responsive to a request comprises accessing location information derived from the position data and related to at least one of said plurality of positions.

16. The method of claim 15, wherein said location information is at least one of street address, postal code, city, state and country.

17. The method of claim 16, wherein said location information includes an index relating said position data of at least one of said plurality of positions to at least one of street address, postal code, city, state and country for, responsive to said request, providing information about movement of the mobile object.

18. The method of claim 17, wherein location information includes an inverted index relating at least one of said street address, postal code, city, state and country to said plurality of positions for, responsive to said request, providing information about movement of the mobile object.

19. The method of claim 16, wherein said location information is a at least of a street map, terrain map and satellite map relating at least one of said plurality of positions to at least one of street address, postal code, city, state and country for, responsive to said request, providing information about movement of the mobile object.

20. A method for providing information about movement of a mobile object to each of a plurality of positions along the Earth's surface, comprising:
obtaining position data related to each of the plurality of positions; and
partitioning the position data for the plurality of positions into a plurality of clusters of related positions that are accessible to provide information in response to a request.

21. The method of claim 20, wherein the step of partitioning the position data comprises storing the plurality of clusters of related positions in a persistent database for selective retrieval therefrom upon request to provide information about movement of the mobile object.

22. The method of claim 20, wherein said partitioning step includes a pre-processing step of warping the position data to take into account that the Earth is approximately spherical

23. The method of claim 22, wherein said partitioning step includes a post-processing step of unwarping the output of the partition step to correct for said preprocessing step.

24. The method of claim 23, wherein said partitioning step includes performing the partitioning each time new position data is obtained.

25. The method of claim 20, further comprising determining a periphery that bounds all positions from among said plurality of positions which are categorized into one of said plurality of clusters.

26. A method for providing information about movement of a mobile object to each of a plurality of positions along the Earth's surface, comprising:
obtaining position data related to each of the plurality of positions;
deriving, based on the position data, an individual map for each of a plurality of said positions; and
animating movement of the mobile object by combining a plurality of said individual maps.

27. The method of claim 26, further comprising storing the individual maps in a persistent database for selective retrieval therefrom upon request to provide information about movement of the mobile object.

28. The method of claim 26, wherein each of said derived maps is one of a street map, terrain map and satellite map relating the position data to at least one of street address, postal code, city, state and country for, responsive to a request, providing information about movement of the mobile object.

29. Apparatus for providing information about movement of a mobile object to each of a plurality of positions along the Earth's surface, comprising:
means for obtaining position data related to each of the plurality of positions; and
means for storing the position data for the plurality of positions in a persistent database for selective retrieval therefrom upon request to provide information about movement of the mobile object.

30. Apparatus for providing information about movement of a mobile object to each of a plurality of positions along the Earth's surface, comprising:
means for collecting in a persistent database position data related to each of the plurality of positions; and
means for, responsive to a request related to a specified time and/or position, providing information about movement of the mobile object corresponding to the specified time and/or position by accessing the position data for the plurality of positions stored in said persistent database.

31. Apparatus for processing information about movement of a mobile object to each of a plurality of positions along the Earth's surface, comprising:
means for obtaining position data related to each of the plurality of positions; and
means for partitioning the position data for the plurality of positions into a plurality of clusters of related positions.

32. Apparatus for providing information about movement of a mobile object to each of a plurality of positions along the Earth's surface, comprising:
means for obtaining position data related to each of the plurality of positions;
means for deriving based on the position data an individual map for each of a plurality of said positions; and
means for animating movement of the mobile object by combining a plurality of said individual maps.
